(19) United States
(12) Patent Application Publication
(10) Pub. No.: US 2014/0053883 A1
(43) Pub. Date: Feb. 27, 2014

(54) CLEANING DEVICE FOR THE NOZZLE OF SLIT COATING MACHINE

(71) Applicant: Jiang Wang, Guangdong (CN)

(72) Inventor: Jiang Wang, Guangdong (CN)

(73) Assignee: SHENZHEN CHINA STAR OPTOELECTRONICS TECHNOLOGY CO. LTD., Shenzhen, Guangdong (CN)

(21) Appl. No.: 13/145,698

(22) PCT Filed: Jun. 3, 2011
(86) PCT No.: PCT/CN11/75262

§ 371 Date: Jul. 21, 2011

(30) Foreign Application Priority Data
May 10, 2011 (CN) 201120146884.3

(51) Int. Cl. B05B 15/02

(52) U.S. Cl. CPC B05B 15/0258
USPC 134/167 R

(57) ABSTRACT

An exemplary cleaning device for the nozzle of the slit coating machine includes a main body. Said main body is provided with a receiving slot for receiving a nozzle of a slit coating machine. Said receiving slot includes a first oblique plane, a second oblique plane and a connecting plane for connecting the first oblique plane and the second oblique plane. A plurality of filling holes for spraying cleaning agent are separately formed on said first oblique plane and said second oblique plane. A faucet is formed on said connecting plane. Said faucet is inserted with a dredge film for dredging the nozzle of the slit coating machine. The invention is able to simultaneously clean and dredge the nozzle of the slit coating machine with less pollutions and shorter working hours in the process of cleaning.

### FIELD OF THE INVENTION

The invention relates to a cleaning device and in particular to a cleaning device for the nozzle of slit coating machine.

### BACKGROUND OF THE INVENTION

In the manufacturing filed of TFT-LCD (Thin Film Transistor-Liquid Crystal Display) panel, it usually needs the nozzle of the slit coating machine to coat the photosensitive resist in the process of manufacturing panels. Therefore, the nozzle of the slit coating machine needs to be cleaned after being coated for some time. The present nozzle of the slit coating machine comprises two oblique planes and a nozzle plane. Said nozzle plane is provided with a slit for coating the photoresist. At present, the two oblique planes for the nozzle of the slit coating machine are cleaned by the cleaning device, however, the photoresist of the slit needs to be manually dredged by using a dredge film. Nevertheless, it needs to open the protective door of the equipment while processing the manual dredge. As a result, the particles and granules generated in such process will pollute the nozzle of the slit coating machine and it will cost much more time to clean these particles and granules.

### SUMMARY OF THE INVENTION

The main purpose of the invention is to provide a cleaning device for the nozzle of the slit coating machine and aims to reduce the pollution and save the working hours.

A cleaning device for the nozzle of the slit coating machine includes a main body. Said main body is provided with a receiving slot for receiving a nozzle of a slit coating machine. Said receiving slot comprises a first oblique plane, a second oblique plane and a connecting plane for connecting said two oblique planes. A plurality of filling holes for spraying cleaning agent are separately formed on said first oblique plane and said second oblique plane. A faucet is formed on said connecting plane. Said faucet is inserted with a dredge film for dredging the nozzle of the slit coating machine. Said cleaning device further includes a motor and a guide frame, wherein said motor is used for driving said main body to move along the length direction of the receiving slot and said guide frame is used for guiding the nozzle of the slit coating machine to vertically move down to the receiving slot.

Preferably, the depth of said faucet ranges from 2 mm to 5 mm.

Preferably, the width of said faucet ranges from 40 um to 100 um, The thickness of said dredge film matches with the width of the faucet.

Preferably, both the width of said faucet and the thickness of said dredge film are 50 um.

The invention further discloses a cleaning device for the nozzle of the slit coating machine includes a main body. Said main body is provided with a receiving slot for receiving the nozzle of a slit coating machine. Said receiving slot includes a first oblique plane, a second oblique plane and a connecting plane for connecting said two oblique planes. A plurality of filling holes for spraying cleaning agent are separately formed on said first oblique plane and said second oblique plane. A faucet is formed on said connecting plane. Said faucet is inserted with a dredge film for dredging the nozzle of the slit coating machine.

Preferably, said faucet is formed on the middle part of the connecting plane.

Preferably, said dredge film is inserted into the faucet vertical to said connecting plane.

Preferably, said cleaning device further includes a guide frame. Said guide frame is used for guiding the nozzle of the slit coating machine to vertically move down to the receiving slot.

Preferably, said cleaning device further includes a motor for driving said main body to move along the length direction of the receiving slot.

Preferably, the cross section of said receiving slot is an inverted trapezoid.

Preferably, the depth of said faucet ranges from 2 mm to 5 mm.

Preferably, the width of said faucet ranges from 40 um to 100 um. The thickness of said dredge film matches with the width of the faucet.

Preferably, both the width of said faucet and the thickness of said dredge film are 50 um.

The two oblique planes of the cleaning device of the invention are capable of cleaning the two oblique planes of the nozzle for the slit coating machine. The dredge film in the faucet is capable of dredging the slit of the nozzle for the slit coating machine, so that it is unnecessary to manually dredge the nozzle of the slit coating machine. Therefore, more particles and granules caused by opening the protective door can be prevented. Additionally, the cleaning device of the invention can simultaneously clean the two oblique planes and dredge the slit for the nozzle of the slit coating machine. Therefore, the device saves massive working hours.

### DESCRIPTION OF ATTACHED DRAWINGS

FIG. 1 is the schematic diagram showing the three-dimensional structure of the first exemplary embodiment of the cleaning device for the nozzle of the slit coating machine of the invention.

FIG. 2 is the schematic diagram showing the three-dimensional structure for the nozzle of the slit coating machine cleaned by the cleaning device.

FIG. 3 is the schematic diagram showing the sectional structure in the process of cleaning the nozzle of the slit coating machine by the cleaning device.

The purpose implementation, the function features and advantages of the invention will be further illustrated by integrating the exemplary embodiments and taking the attached drawings as references.

### DETAILED DESCRIPTION OF THE EMBODIMENTS

It should be understood that the described exemplary embodiment is only used for illustrating this invention rather than limiting this invention.

As is shown in FIG. 1, which is the schematic diagram showing the three-dimensional structure of the first exemplary embodiment of the cleaning device for the nozzle of the slit coating machine of the invention. Such cleaning device includes a main body 100, and a receiving slot 101 is formed on the main body 100 for receiving the nozzle of the slit coating machine. The receiving slot 101 includes a first oblique plane 102, a second oblique plane 103 and a connecting plane 104 for connecting the first oblique plane 102 and the second oblique plane 103. The connecting plane 104 is arranged at the bottom of the receiving slot 101. A plurality of filling holes 105 for spraying cleaning agent are separately formed on the first oblique plane 102 and the second oblique plane 103. A faucet 106 is formed on said connecting plane 104 for inserting the dredge film 107. The faucet 106 is formed on the middle part of the connecting plane 104. The dredge film 107 is vertical to said connecting plane 104 and inserted into the faucet 106 through manpower or mechanism equipment.

Said cleaning device further includes a motor (not shown in the drawings) for driving said main body 100 to move along the length direction of said receiving slot 101.

In this exemplary embodiment, the depth of the faucet 106 ranges from 2 mm to 5 mm and the width thereof ranges from 40 um to 100 um. The thickness of said dredge film 107 relatively matches with the width of the faucet 106. The dredge film 107 can be exactly and firmly inserted into the faucet 106. The width of the faucet 106 and the thickness of the dredge film 107 preferably select 50 um. The dredge film 107 is made of metal materials such as steel sheets or cooper sheets and so on, which are provided with stronger hardness. In other exemplary embodiments, the thickness of the dredge film 107 and the width of the faucet 106 are determined according to the practical cleaned nozzle slit so as to exert better cleaning effect.

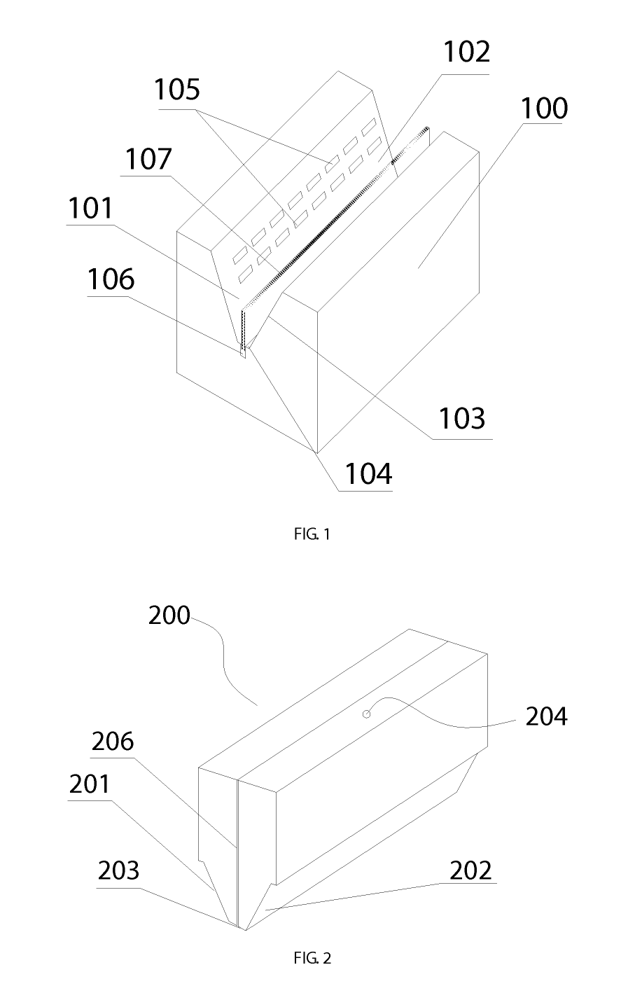

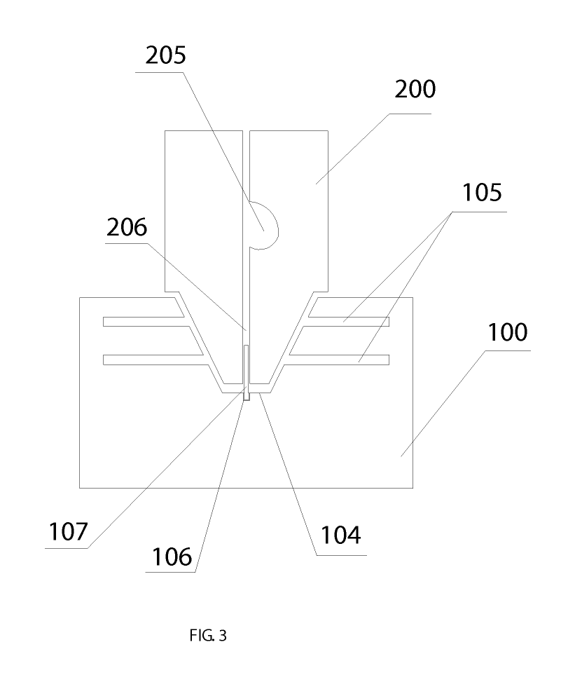

Taking FIG. 2 and FIG. 3 as references, wherein FIG. 2 is the schematic diagram showing the three-dimensional structure for the nozzle of the slit coating machine cleaned by the cleaning device shown in FIG. 1 and FIG. 3 is the schematic diagram showing the sectional structure in the process of cleaning the nozzle of the slit coating machine by the cleaning device shown in FIG. 1. The bottom part of the nozzle 200 for the slit coating machine includes a third oblique plane 201, a fourth oblique plane 202 and a nozzle plane 203. The top part of the nozzle 200 for the slit coating machine is provided with a hole 204, and the inner part of the nozzle 200 is provided with a cavity 205 communicated with such hole 204 and a slit 206 communicated with such cavity 205. The photoresist is filled into the nozzle 200 of the slit coating machine from such hole 204 and is then stored into the cavity 205 within the nozzle 200 of the slit coating machine for cleaning the slit 206.

Said third oblique plane 201, said fourth oblique plane 202 and said nozzle plane 203 for the nozzle 200 of the slit coating machine are respectively matched with said first oblique plane 102, said second oblique plane 103 and said connecting plane 104 of the cleaning device. Both the cross section for the receiving slot 101 of the cleaning device and the cross section for the nozzle 200 of the slit coating machine are inverted trapezoids, which are matched and connected with each other.

While using the cleaning device of the invention, firstly inserting said dredge film 107 on the faucet 106 at the bottom of the receiving slot 101 for the cleaning device, then placing the bottom part of the nozzle 200 of the slit coating machine into the receiving slot 101 of the cleaning device. Meanwhile, inserting the dredge film 107 into the slit 206 of the nozzle of the slit coating machine. The filling holes 105 on the first oblique plane 102 and the second oblique plane 103 will spray cleaning agent to clean the third oblique plane 201 and the fourth oblique plane 202 for the nozzle 200 of the slit coating machine. In the cleaning process, the photoresist outflows from the slit 206 of the nozzle 200 of the slit coating machine. At the same time, the motor drives the main body 100 to move forward and backward along the length direction of the receiving slot 101 in order to make the dredge film 107 move forward and backward into the slit 206 so as to conveniently dredge the slit 206.

The cleaning device of the invention can directly clean and dredge the nozzle 200 of the slit coating machine without any manual work to dredge the nozzle of the slit coating machine. As a result, more particles and granules caused by opening the protective door of the equipment can be avoided. Additionally, the cleaning device of the invention can simultaneously clean the two oblique planes 201,202 and dredge the slit 206 for the nozzle 200 of the slit coating machine. Therefore, the device saves massive working hours.

The cleaning device for the nozzle of the slit coating machine in the second exemplary embodiment of the invention is approximately same with that of the first exemplary embodiment. However, they have the following differences: the cleaning device of the second exemplary embodiment further includes a guide frame (not shown in the drawings). Said guide frame is used for guiding the nozzle 200 of the slit coating machine to vertically move down to the receiving slot 101 so as to enable the dredge film 107 to be exactly inserted into the slit 206.

What is illustrated above is just a preferable exemplary embodiment, which will not limit the patent scope of the invention. Any equivalent replacements made by the specifications and drawings of the invention, which are directly or indirectly applied to other technical fields, should be included into the protection scope of the invention.

What is claimed is:

1. A cleaning device for the nozzle of slit coating machine, comprising a main body, wherein said main body is provided with a receiving slot for receiving a nozzle of a slit coating machine, said receiving slot comprises a first oblique plane, a second oblique plane and a connecting plane for connecting said two oblique planes, a plurality of filling holes for spraying cleaning agent are separately formed on said first oblique plane and said second oblique plane, a faucet is formed on said connecting plane, said faucet is inserted with a dredge film for dredging the nozzle of the slit coating machine, said cleaning device further comprises a motor and a guide frame, wherein said motor is used for driving said main body to move along the length direction of the receiving slot and said guide frame is used for guiding the nozzle of the slit coating machine to vertically move down to the receiving slot.

2. The cleaning device for the nozzle of the slit coating machine of claim 1, wherein the depth of said faucet ranges from 2 mm to 5 mm.

3. The cleaning device for the nozzle of the slit coating machine of claim 1, wherein the width of said faucet ranges from 40 um to 100 um, the thickness of said dredge film matches with the width of the faucet.

4. The cleaning device for the nozzle of the slit coating machine of claim 3, wherein both the width of said faucet and the thickness of said dredge film are 50 um.

5. A cleaning device for the nozzle of the slit coating machine, comprising a main body, wherein said main body is provided with a receiving slot for receiving a nozzle of a slit coating machine, said receiving slot comprises a first oblique plane, a second oblique plane and a connecting plane for connecting said two oblique planes, a plurality of filling holes for spraying cleaning agent are separately formed on said first oblique plane and said second oblique plane, a faucet is formed on said connecting plane, and said faucet is inserted with a dredge film for dredging the nozzle of the slit coating machine.

6. The cleaning device for the nozzle of the slit coating machine of claim 5, wherein said faucet is formed on the middle part of the connecting plane.

7. The cleaning device for the nozzle of the slit coating machine of claim 5, wherein said dredge film is inserted into the faucet vertical to said connecting plane.

8. The cleaning device for the nozzle of the slit coating machine of claim 5, wherein said cleaning device further comprises a guide frame, said guide frame is used for guiding the nozzle of the slit coating machine to vertically move down to the receiving slot.

9. The cleaning device for the nozzle of the slit coating machine of claim 5, wherein said cleaning device further comprises a motor for driving said main body to move along the length direction of the receiving slot.

10. The cleaning device for the nozzle of the slit coating machine of claim 5, wherein the cross section of said receiving slot is an inverted trapezoid.

11. The cleaning device for the nozzle of the slit coating machine of claim 5, wherein the depth of said faucet ranges from 2 mm to 5 mm.

12. The cleaning device for the nozzle of the slit coating machine of claim 5, wherein the width of said faucet ranges from 40 um to 100 um, and the thickness of said dredge film matches with the width of the faucet.

13. The cleaning device for the nozzle of the slit coating machine of claim 12, wherein both the width of said faucet and the thickness of said dredge film are 50 um.
